(19) United States
(12) Patent Application Publication
(10) Pub. No.: US 2011/0008747 A1
(43) Pub. Date: Jan. 13, 2011

(54) Method and Apparatus for Electronically Modeling and Manufacturing Dentures

(75) Inventors: Prasad Adusumilli, Parsippany, NJ (US); Stanley J. Lech, Parsippany, NJ (US); Zvi G. Loewy, Parsippany, NJ (US)

Correspondence Address: GlaxoSmithKline;GLOBAL PATENTS -US, UW2220, P. O. BOX 1539, KING OF PRUSSIA, PA, 19406-0939, US

(73) Assignee: GlaxoSmithKline LLC

(21) Appl. No.: 12/918,355

(22) PCT Filed: Feb. 20, 2009
(86) PCT No.: PCT/US09/34700

§ 371 Date: Aug. 19, 2010

Related U.S. Application Data
(60) Provisional application No. 61/030,842, filed on Feb. 22, 2008.
(60) Provisional application No. 61/030,831, filed on Feb. 22, 2008.
(60) Provisional application No. 61/030,810, filed on Feb. 22, 2008.

(51) Int. Cl. A61C 11/00; G06F 19/00

(52) U.S. Cl. 433/54; 700/98

(57) ABSTRACT

A method and apparatus for making a dental appliance of a patient is provided. An electronic scan is made to collect data about the anatomy of the patient's mouth. The first computer digitally receives the data processes it with data of the patient to create facebow data, and transmitting the facebow data to a second computer, which transfers the facebow data to a second articulator. The second articulator duplicates the set up of the first articulator based on that data.

### BACKGROUND OF THE INVENTION

1. Field of the Invention

The present disclosure relates to methods and apparatus for electronically modeling and manufacturing dentures. In particular, the present disclosure relates to methods and apparatus for electronically modeling dental articulation and digital interaction between the dentist and the denture manufacturer.

2. Description of the Related Art

Dentists have long used human-designed, physical models of a patient's mouth to copy the interaction of the patient's opposing jaws for making dentures and other appliances. Computer-aided creation of electronic models, which correspond to such physical models, is more efficient and reliable for this purpose than ones based on human measurement and observation.

One application of this electronic modeling technology is in measuring articulation of the jaws; namely, the shift in position of a patient's left and right mandibular condyles caused by the movement of the mandible. The mandibular condyles are the rounded prominances at the end of the mandible that articulate with the maxilla. However, the mandible and maxilla do not interact in a strictly hinge-like fashion, rotating about a fixed point. Rather, during jaw articulation, in which the mandible moves with respect to the maxilla, each condyle shifts with respect to its original position and/or the other condyle. Taking this shift in position into account in making dentures and other appliances is critical for creating the proper jaw relationship. Otherwise, manufacture of the denture to replicate movement of the patient's jaws about the temporal mandibular joint, or oral hinge axis, will not properly mimic the natural jaw movement.

A computer-aided manipulation of electronic models, which correspond to physical models of the jaws and the articulation between them, is known. However, this electronic system does not use the data derived from the electronic models in a coordinated effort between the dentist and denture manufacturer to more efficiently and accurately manufacture a denture.

### SUMMARY OF THE DISCLOSURE

The present disclosure provides methods for using electronic models in dental articulation that overcome problems associated with making dentures and other appliances only from physical models.

The present disclosure also provides such methods that allow for coordination between the dentist and denture manufacturer so they use the same data, to provide accuracy and efficiency in such manufacture.

The present disclosure further provides for improved efficiencies by minimizing dentist preparation time, reducing the number of physical models that would ordinarily be required to be made, and reducing the wait time for the patient between visits.

The present disclosure uses a computer system in conjunction with digital dental image data to provide articulation so that once the proper articulation is established for a patient, it does not have to be recalculated, redone or physically transferred, during various interactions between the dentist and the manufacturer of the denture.

The present disclosure further provides a scan of the patient's oral cavity to obtain a digital image of the cavity, a computer system to receive the digital data and factor patient information, and then set up a first articulator at the dentist's office and a second articulator at the site of the denture manufacturer with facebow data.

According to the present disclosure, a dentist uses digital technology to obtain the measurements, and thus data, necessary to make a denture for a particular patient. The data collected is stored and transferred digitally to the computers and then articulators located at the dentist's office and the denture manufacturer's site as part of the dentist's prescription for the denture. Thus, the articulators at the denture manufacturer and the dentist's office mirror each other for any given patient.

In addition, receipt of the dentist prescription triggers the computer system at the denture manufacturer's site to schedule fabrication of required parts and produce the parts per schedule. That articulator receives this data automatically from the network or a USB port or by any other method of data transfer and sets itself up to provide proper anatomical data of the patient's oral cavity, such as proper occlusal plane and vertical dimension, and the proper bite registration. Also, when an articulator is used, either in the dentist's office or the denture manufacturer, the data is automatically transferred to both articulators.

### BRIEF DESCRIPTION OF THE DRAWINGS

FIG. 1A illustrates a prior art articulator with a denture therein that can be used in a method of the present disclosure.

FIG. 1B illustrates a prior art articulator without a denture therein that can be used in a method of the present disclosure.

FIG. 2 is an illustration of a digital scan made of a patient and transfer of patient data useful for the practice of a method of the present disclosure.

FIG. 3 is a pictorial representation of a patient's face and digital images and measurements of the patient.

FIG. 4 is an illustration of digital transfer of patient data and communication between the articulator in the dentist's office and the articulator at the site of the denture manufacturer.

### DETAILED DESCRIPTION OF THE DISCLOSURE

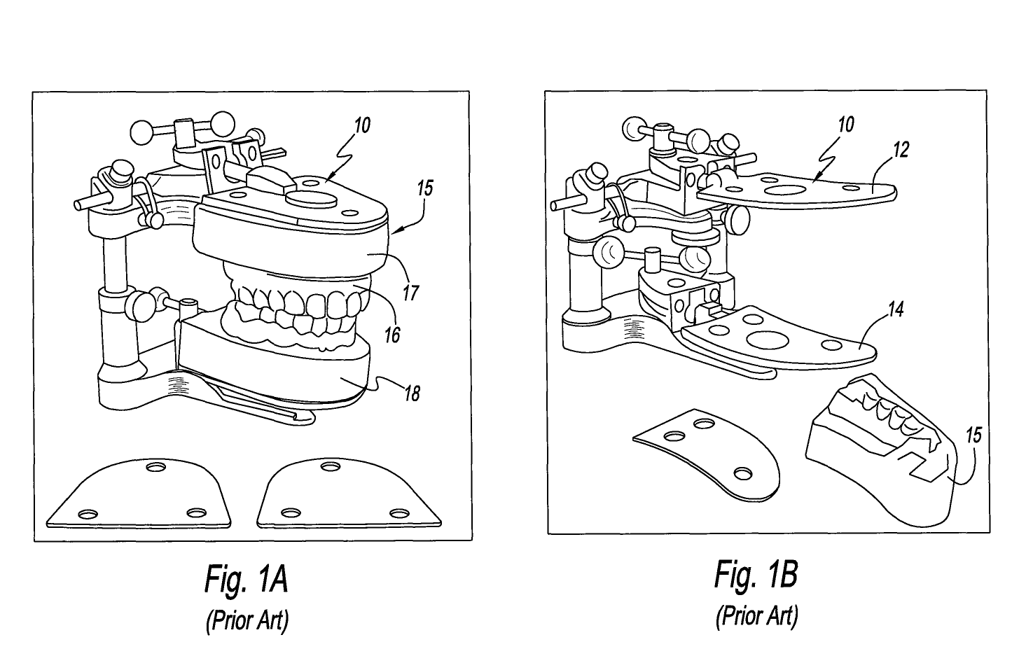

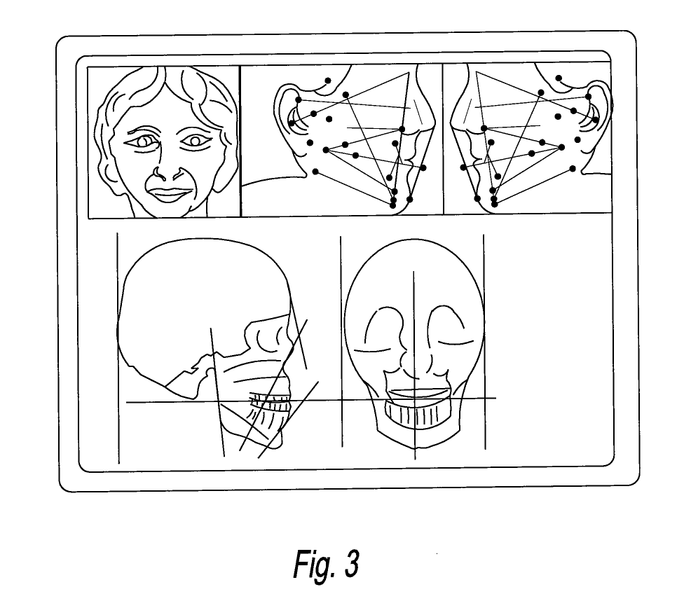

Referring to the drawings and, in particular, FIGS. 1A and 1B, a first prior art articulator generally represented by reference numeral 10 is shown. First articulator 10 is used by a dentist to design an anatomical model of the patient's jaws and the relationship of the jaws with the tempero mandibular joint. By anatomical model in the present disclosure, it means anatomical feature of the patient's face and oral cavity, and all relations therebetween. The term anatomical measurements in the present disclosure, includes intraoral measurements of the face and relative positioning of the parts of the mouth to the face, and includes all variables such as occlusal plane, vertical dimension, namely the vertical distance between the lower face height measured from a chin point to a point just below the nose, the relationship of the upper teeth to the lower teeth, in accordance with Wilson and Spee curves, bite registration, and other such measurements as shown in FIG. 3. The Wilson curve is a lateral curve of the occlusal table formed by the lingual inclination of the posterior teeth, and because the lingual cusps are lower than the buccal cusps, they form a curve with their antimeres. The Spee curve is an anatomic curvature of the occlusal alignment of teeth, beginning at the tip of the lower canine, following the buccal cusps of the natural premolars and molars, and continuing to the anterior border of the ramus.

Using first articulator 10, the anatomical model 15 is created by connecting a facebow record with a base plate 16 to an upper jaw stone model 17 on an upper support plate 12. The facebow record is then removed. This provides the proper occlusal plane of the patient. The bite record is then placed on the upper jaw stone model 17. A lower jaw stone model 18 is connected to the bite record and to a lower support plate 14 on first articulator 10. The lower and upper stone models 17, 18 are held in place on first articulator 10 by putty or stone. First articulator 10 is also physically adjusted to provide the required vertical dimension of the patient. In addition, first articulator 10 assists in determining proper occlusion for the teeth and bite registration.

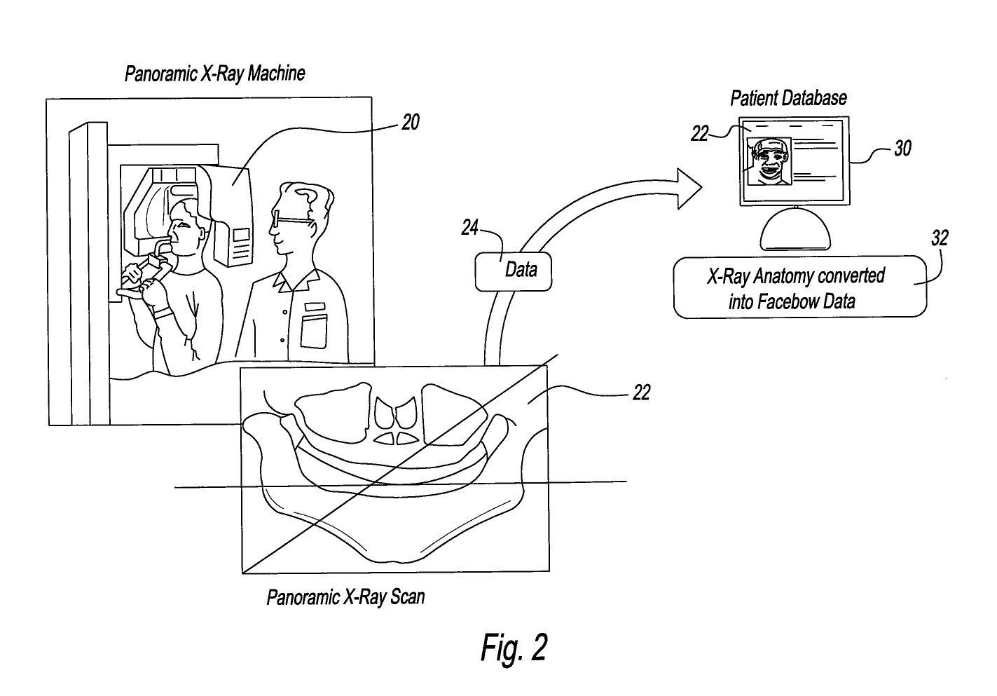

Referring to FIG. 2, according to the present disclosure, a dentist uses digital technology devices 20 to obtain anatomical measurements and pictures of the patient's anatomical features 22, and thus data 24, necessary to make a denture for a particular patient. Suitable devices 20 include, but are not limited to, a panoramic X-ray, CAT scan or MRI.

FIG. 3 illustrates some of the anatomical measurements and anatomical model of the patient. For example, the vertical dimension 40 is shown.

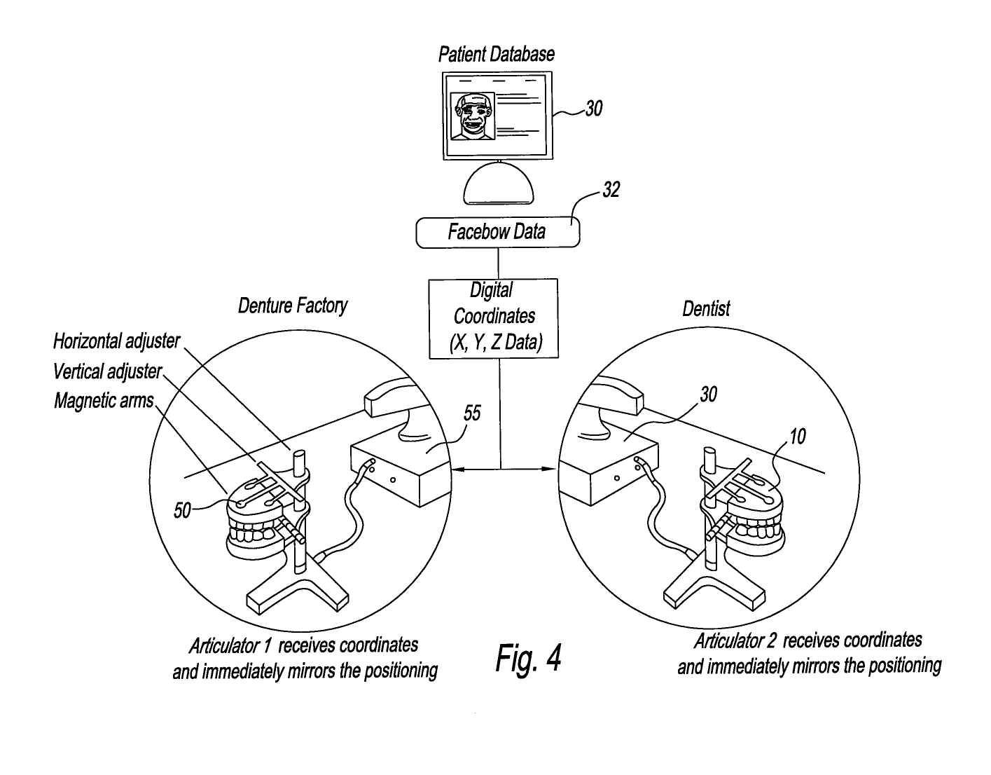

Referring to FIGS. 2 and 4, the data 24 collected is stored and transferred digitally to first computer 30 in the dentist's office or site. First computer 30 has other or patient information about the patient. The data 24 and parameters and relationships between data 24 and patient data are then processed by first computer 30, to produce facebow data 32. The processing or assimilation of data 24, patient data and the parameters and relationships therebetween to provide facebow data 32 is by conventional programs in first computer 30. The facebow data 32 is then stored in the patient's file so that patient data in first computer 30 is updated. As shown in FIG. 4, the updated, facebow data 32 is sent by first computer 30 to articulator 10 in the dentist's office and also to a second computer 55, and thus second articulator 50, in the denture manufacturer's site as part of a digital prescription. Thus, both first and second computers 30, 55 receive the same data via normal communication channels between computers. Also, each first and second computer 30, 55 instructs and sends the same data to its respective first and second articulator 10, 50, almost instantaneously thereby insuring entirely consistent, reproducible articulation in each articulator.

The denture manufacturer creates a virtual denture using articulator 50 based on facebow data 32. The denture manufacturer, when making the first or trial denture, may change some measurements or data points. The present disclosure provides that second articulator 50 will communicate with its computer 55 and store this updated information therein, and communicate and store the updated information in first computer 30. First computer 30 will transport the updated information to first articulator 10 to set up or readjust first articulator 10.

The dentist and denture manufacturer can, thus, digitally transfer data generated about the trial denture between themselves and at the same time adjust their respective articulators. Such data transfer avoids the present problem of making several physical dentures and shipping the dentures back and forth. Once modification of the virtual denture is completed, the denture manufacturer makes a physical wax denture and ships, the physical wax denture to the dentist. Further modifications to the physical wax denture are unlikely due to the immediate sharing of identical data. This minimizes modifications required to the physical wax denture by the denture manufacturer. The denture manufacturer can more easily create new dentures if needed based on the dentist's requirements and reduce the time period between trial dentures.

Thus, the present method avoids the physical transfer of the measurements, and any movement of the denture manufacturer's articulator 50 to the dentist, and also avoids repeating of measurements, due to the almost instantaneous digital transfer of information between the dentist's articulator 10 and the manufacturer's articulator 50. Accordingly, there is a minimized opportunity for error or for unintended change in the measurements. There is also much easier and less time consuming adjustment of the denture while in the patient, since the articulator does not have to be set up each time it is used.

In another aspect of the present disclosure, receipt of the facebow data 32 triggers second computer 55 at the denture manufacturer to schedule fabrication of required parts and produce the parts per schedule. During this fabrication process, when either articulator 10, 50 is used and updated information produced, the updated information is automatically downloaded and each articulator is allowed to set itself up. Each articulator 10, 50 is designed to receive data/information automatically from the network or a USB port or by any other method of data transfer and set itself. Thus, second articulator 50 at the denture manufacturer, and first articulator 10 at the dentist's office, mirror each other for any given patient.

The present disclosure also provides for an improvement to first articulator 10 of the prior art. In place of putty or stone material to attach the upper and lower stones 17, 18 to articulator 10, magnets can be inserted into the stones and the articulator to make it easier for their adjustment or removal from each other. The use of electro magnets, which can be turned on or off with electricity, would be most optimum.

The present disclosure has been described with particular reference to certain embodiments. It should be understood that the foregoing descriptions and examples are only illustrative of the invention. Various alternatives and modifications thereof can be devised by those skilled in the art without departing from the spirit and scope of the present disclosure. Accordingly, the present disclosure is intended to embrace all such alternatives, modifications, and variations that fall within the scope of the appended claims.

What is claimed is:

1. A method for making a dental appliance comprising:
electronically scanning anatomical features of a patient to collect data about the patient;
using a first computer to digitally receive the data, the first computer having additional data about the patient and converting the data and additional data into facebow data, the first computer digitally transmitting the facebow data;
providing a second computer to receive the facebow data from the first computer; and
providing a second articulator to receive the facebow data from the second computer and duplicate the set up of the first articulator based on the facebow data.

2. The method according to claim 1, further comprising providing a first articulator to receive the facebow data from the first computer.

3. The method according to claim 2, wherein the facebow data transmitted to the first articulator and the second articulator is the same.

4. The method according to claim 3, wherein the facebow data is updated based on new data received by either the first computer or the second computer.

5. The method according to claim 4, wherein the updated facebow data is sent to the either of the first computer and the second computer.

6. The method according to claim 5, wherein the other of the first computer and the second computer updates its respective first articulator or second articulator.

7. The method according to claim 1, wherein the facebow data is updated based on new data received by either the first computer or the second computer.

8. The method according to claim 1, wherein the facebow data can be adjusted by the second computer and communicated to the first computer.

9. The method according to claim 1, wherein the second computer receipt of the facebow data triggers the second computer to schedule fabrication.

10. The method according to claim 9, wherein the schedule fabrication includes producing parts for the making the dental appliance.

11. The method according to claim 1, wherein the dental appliance is a denture.

12. An apparatus for making a dental appliance comprising:
a device for electronically scanning the anatomical features of a patient and to collect data about the patient;
a first computer to digitally receive the data and compare it to patient data to produce facebow data of the patient, the computer digitally transmitting the facebow data;
a first articulator to receive the facebow data from the first computer;
a second computer to receive the facebow data from the first computer; and
a second articulator to receive the facebow data from the second computer.

13. The apparatus according to claim 12, wherein the first articulator receives the facebow data from the first computer to set up the first articulator.

14. The apparatus according to claim 13, wherein the the second articulator is set upon receipt of the facebow data.

15. The apparatus according to claim 13, wherein the the second articulator is set up upon receipt of the facebow data received from the second computer that, in turn, receives the facebow data from the first computer.

16. The apparatus according to claim 13, wherein the the second articulator provides further updated data during manufacturing of the dental appliance.

17. The apparatus according to claim 16, wherein the further updated data from the second articulator is transmitted to the first articulator to update the first articulator.

18. The apparatus according to claim 15, wherein the dental appliance is a denture.

19. The apparatus according to claim 12, wherein one or both of the first and second articulators includes lower and upper stones and one or more magnets attaching the stones.

20. The apparatus according to claim 19, wherein the one or more magnets is an electro magnet.
